(19) United States
(12) Patent Application Publication
(10) Pub. No.: US 2002/0134489 A1
(43) Pub. Date: Sep. 26, 2002

(54) Self-dispensing fastener for photocuring adhesive

(76) Inventors: Theodore J. Sweeney JR., Grosse Pointe Farms, MI (US); Drew J. Smith, Bloomfield Hills, MI (US); Aron R. Lorenz, Silver Lake, MI (US)

Correspondence Address: Ralph M. Burton, Brooks & Kushman P.C., 1000 Town Center, 22nd Floor, Southfield, MI, 48075-1351, US

(21) Appl. No.: 10/143,099

(22) Filed: May 10, 2002

Related U.S. Application Data
(63) Continuation-in-part of application No. 09/998,144, filed on Nov. 30, 2001.
Application No. 09/998,144 is a continuation-in-part of application No. 09/585,504, filed on Jun. 1, 2000, now abandoned.
Application No. 09/585,504 is a continuation of application No. 09/075,583, filed on May 11, 1998, now abandoned.

(51) Int. Cl. B32B 7/08

(52) U.S. Cl. 156/108; 156/92

(57) ABSTRACT

A self-dispensing fastener for attachment to a substrate by a quick-setting photocuring adhesive has a UV transparent flange for placement against the substrate and UV opaque adhesive reservoir for containing the adhesive in the fastener, and upon pressing the fastener against the substrate the adhesive is expelled into the interface formed between the flange and the substrate for curing by UV radiation.

### CROSS-REFERENCE TO RELATED APPLICATIONS

This application is a continuation-in-part of co-pending U.S. application Ser. No. 09/998,144 filed Nov. 30, 2001 which is a continuation-in-part of U.S. application Ser. No. 09/585,504 filed Jun. 1, 2000, now abandoned, which was a continuation of U.S. application Ser. No. 09/075,583 filed May 11, 1998, now abandoned.

### BACKGROUND OF THE INVENTION

1. Field of the Invention

This invention relates to adhesively secured fasteners utilizing quick-setting, photocuring adhesives.

2. Background Art

U.S. Pat. Nos. B1 5,044,853 and 5,277,530 show a fastener for quick attachment to a substrate. The fastener is simply depressed against the substrate and a quick-setting adhesive is dispensed into the interface between the fastener and the substrate thereby attaching the fastener. Anaerobic and several other adhesives may be used quite satisfactorily with such fasteners.

However, there are some situations where it has become desirable to utilize a photocuring adhesive rather than those previously used. As used herein, a photosensitive or photocuring adhesive is one which cures upon exposure to radiation in the visible and ultraviolet light spectrums.

Utilizing photocuring adhesives requires that the adhesive be effectively shielded from the curing radiation, otherwise the adhesive will cure prematurely in the fastener rendering the fastener useless. At the same time, when the fastener is pressed against the substrate to which it is to be secured, it must be possible to illuminate the adhesive at the interface between the fastener and the substrate to cure it. As used herein, the term “illuminate” includes radiation in the visible and UV spectrums.

### SUMMARY OF THE INVENTION

I have discovered approaches which render use of a photocuring adhesive feasible in fasteners of the general type shown in the aforesaid patents. In one embodiment, the adhesive is stored in a reservoir made of UV opaque material which is placed in a UV transparent fastener such that upon expelling the adhesive into an interface between the fastener and the substrate to which the fastener is to be secured, UV light can contact the adhesive in such interface to effect the cure.

In another embodiment the fastener has a UV opaque chamber in which the adhesive is stored, and the portion which forms an interface with the substrate is sufficiently transparent to UV radiation that adhesive expelled into the interface from such chamber can be cured. In still another embodiment, the fastener is opaque to the UV spectrum, but is used on UV transparent substrates, such as glass or clear plastic, such that UV radiation may reach the photocuring adhesive in the interface between the fastener and the substrate by having the light pass through the substrate beneath the fastener.

In another embodiment, the adhesive reservoir and plunger are made of a material which is opaque to UV radiation but at least one of them is transparent to visible light, whereby the reservoir when filled with adhesive and stopped with a plunger may be visually inspected to determine whether it contains adhesive.

In a further embodiment the fastener body is transparent to UV radiation and the design of the fastener is such that UV radiation directed axially of the fastener against the end opposite the end to be attached to a substrate, passes through the fastener body to the UV adhesive at the end to be attached to the substrate to effect a very rapid cure of the adhesive.

Other embodiments which may be combinations of the aforesaid will become apparent as this description proceeds.

I have also discovered that adhesion of the fastener to the frit-covered margin of a vehicle window may be improved by coating such margin with a primer. Several primers useful for this purpose are described herein.

Apparatus for affixing self-dispensing UV curable adhesive fasteners on windows to be installed in automotive vehicle bodies is also disclosed. Such apparatus includes applicators for holding the fasteners and pressing them against the window and a light source in each applicator which will direct light through a transparent flange of the fastener to cure UV curable adhesive disposed between the flange and the window. The apparatus also includes a fixture for holding the window in a determined position relative to the applicator so that the fasteners held by the applicators will be affixed to the window in predetermined locations. The applicators may be so constructed and arranged that the UV radiation will be shielded from the eyes of personnel working at the fastener applying apparatus.

Where fasteners are utilized which have a body transparent to UV radiation, apparatus is disclosed for holding the fastener upright against the substrate to which it is to be attached to cause quick-setting UV and adhesive to be expelled into the interface between the fastener and the substrate, and directing UV radiation axially of the fastener to cause rapid curing of the adhesive between the fastener and the substrate.

### BRIEF DESCRIPTION OF THE DRAWINGS

FIG. 1 is a perspective view of the rear portion of a motor vehicle utilizing my invention to hold the rear window in the vehicle body during assembly of the vehicle;

FIG. 2 is a fragmentary perspective view of a motor vehicle window showing my improved fasteners adhered thereto;

FIG. 3 is a cross-sectional view taken on the line 3-3 of FIG. 2;

FIG. 4 is a perspective view of another embodiment of the invention;

FIG. 5A is a cross-sectional view through the fastener of FIG. 4;

FIG. 5B is a cross-sectional view through the fastener of FIG. 4 after the nose portion of the fastener has been broken off;

FIG. 6 is a cross-sectional view taken on the line 6-6 of FIG. 8 showing a fastener pressed by an applicator against the surface of a window with the UV-cured adhesive disposed between the flange of the fastener and the window;

FIG. 7 is similar to FIG. 6 except the light source is creating the radiation at the fastener flange to cure the adhesive;

FIG. 8 shows an apparatus and fixture for orienting a window in relation to the applicators for applying fasteners thereto;

FIG. 9 shows a fastener held by an applicator prior to being pressed against an automobile window or other substrate; and

FIG. 10 is a cross-sectional view through an applicator holding a fastener with a body transparent to UV radiation for directing such radiation axially of the fastener.

### DETAILED DESCRIPTION OF THE PREFERRED EMBODIMENT(S)

While my invention is usable for fixing a fastener or other part to any substrate utilizing a photocuring adhesive, I have disclosed it here in connection with fasteners used to locate and hold window glass in place in a vehicle body as it passes down the assembly line during construction of the motor vehicle.

In many instances, the windows of motor vehicles are held in place utilizing a construction adhesive which requires several hours to cure. Because the windows are installed in the body while it is still on the assembly line and subject to vibration and jostling, means must be provided to locate and hold the windows in place and prevent unwanted shifting thereof in the window opening while assembly of the vehicle continues and before the construction adhesive has fully cured. Various expedients have been used in the past with varying success, but there has remained the need for a locating and holding device (or fastener) which is both easy to use and inexpensive.

Referring to the fasteners disclosed in the aforesaid patents, it was thought such a fastener could be attached to the window glass and adapted to cooperate with the vehicle body to hold the glass in place. However, in some instances, automobile manufacturers were not satisfied with the bonding strength of prior adhesives to secure the fasteners to the window glass. It was discovered that the quick-setting adhesives heretofore used in such fasteners did not hold quite as well on windows painted with an opaque frit at the marginal edges to hide the construction adhesive. While the construction adhesive adhered sufficiently to the frit coating, the quick-setting adhesive of the fasteners did not adhere sufficiently to satisfy all the vehicle manufacturers.

A quick-setting adhesive I have discovered that will satisfy the vehicle manufacturers who disliked the bonding strength of the prior adhesives to the frit coated surface of the windows, is a photocuring adhesive. Such adhesive exists which may be cured rapidly, i.e., in but a few seconds, utilizing visible light or ultraviolet light. However, the opaque frit on the marginal edge of the window sufficiently blocks the radiation that it cannot penetrate through to the adhesive to effect a quick cure. In fact, the fasteners themselves have been heretofore made of an opaque plastic material that, similar to the frit, prevents illumination reaching the adhesive. If photocuring adhesive is stored in fasteners which are not opaque, it must be shielded from illumination otherwise the adhesive will cure in the fastener rendering them useless.

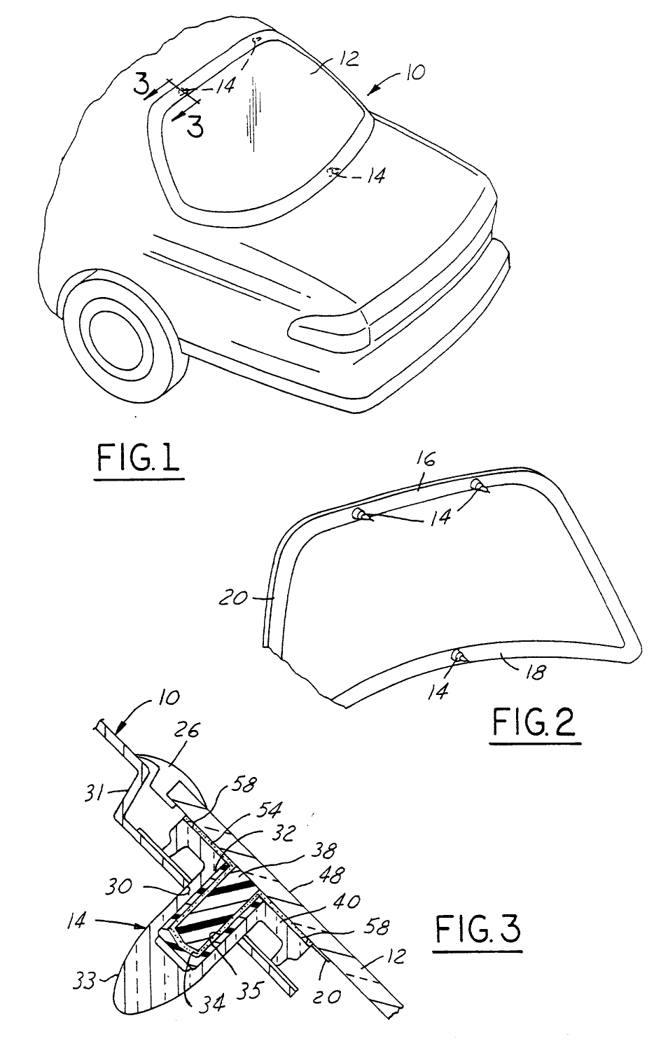

In the drawings, I show the rear portion of a motor vehicle 10 having a rear light (or window) 12 installed therein and located by fasteners 14. The fasteners are disposed in spaced relation at the marginal edge of the rear light as shown in FIG. 2 —two being adjacent the top edge 16, and one adjacent the bottom 18. Because the glass is held in the window opening by a construction adhesive (not shown) which takes some time to cure, the fasteners hold the glass in place during such curing. An opaque frit layer 20 overlies the marginal edge of the glass to hide the construction adhesive and thereby improve the aesthetic appearance of the installed glass. The frit layer 20 is sufficiently opaque to illumination that rapid cure of a photocuring adhesive by exposing the backside of the glass to illumination is ineffective.

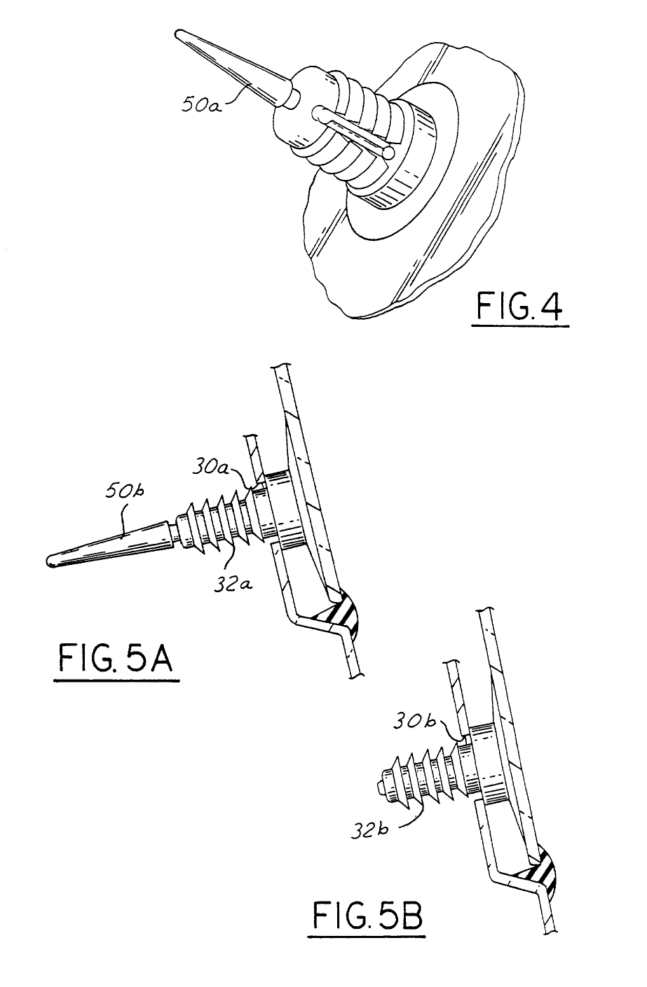

Referring now to FIGS. 2 and 3 as well as FIG. 4 of U.S. Pat. No. 5,277,530, which patent is incorporated herein by reference, and with respect to which I have used, where convenient, corresponding reference numerals, I provide a fastener, having a body 32, with an integral flange 40 at one end and a tapered locating nose 33 at the opposite end. The body 32 is generally elongated and interiorly provided with an adhesive storage cavity 35 similar to the arrangement shown in U.S. Pat. No. 5,277,530. In the preferred embodiment, an adhesive reservoir 34 is received in the cavity 35. The reservoir contains a supply of adhesive 36 which is expelled therefrom by a piston or plunger 38 as the fastener is pressed against the glass 12, and extruded into the interface 54 formed between the flange 40 and the glass 12. The details of the reservoir and plunger design, and the operation thereof is fully recited in U.S. Pat. No. 5,277,530 and need not be repeated here.

Suffice it that, to deploy the fastener and adhere it to the glass, it is positioned as desired on the window, such as in the positions shown in FIGS. 1 and 2, and then with the plunger 38 positioned against the glass, the fastener is urged against the glass to depress the plunger to expel the adhesive into the interface as at 54. At this point, curing of the adhesive is required.

After the adhesive 36 has cured, the nose 33 is received in an opening or locating device 30 in the body panel 31 around the window opening. Construction adhesive, not shown, will lie in the space between the body panel 31 and the glass 12 in engagement with the frit layer 20. In this way, the fastener holds the window in place while the construction adhesive cures. A trim strip 26 received over the edge of the glass overlies the body 10 and bridges the gap between the glass and the body.

Because a photocuring adhesive is used in the fastener, once the adhesive is extruded into the interface as at 54, the adhesive must be exposed to illumination such as ultraviolet light to cure it. Because the frit layer 20 is too opaque to allow UV radiation therethrough, the adhesive cannot be cured quickly by directing a UV light against the exposed face 48 of the glass. Accordingly, I propose that the fastener body 32 and more specifically the flange 40 be molded of a plastic material sufficiently transparent to ultraviolet light that the adhesive at 54 cures quickly. In practice, the entire fastener may be transparent to UV radiation.

One such plastic material is sold by BASF under the trademark TERLUX. This is a clear ABS plastic which will allow UV radiation to penetrate the flange 40 to substantially instantly cure the adhesive. Other plastics compatible with the photocuring adhesive may also be used, such as a Bisphenol A polycarbonate manufactured by Bayer Corporation and sold under the trademark Makrolon™2405 550115, or Durethan™ T 40 XS 5014/3 made by the same company.

I have found that a suitable photocuring adhesive is sold under the trademark DYMAX by Dymax Corporation of 51 Greenwoods Rd., Torrington, Conn. 06790. This is a polyurethane Oligomer Mixture, sold under the product identification 3-3094. Other adhesives may be used which are sufficiently strong and meet the other requirements of the application.

Once the adhesive has been dispersed into the interface beneath the flange 40, an ultraviolet light is directed toward the fastener, and such radiation will pass through the flange and instantly cure the adhesive. I have found that this adhesive adheres well to the frit coating on the automotive glass.

To prevent the adhesive from curing while stored in the reservoir in the fastener body before being extruded, the reservoir 34 and the plunger 38 should be made of materials sufficiently opaque to illumination that the adhesive will not cure for long periods. In many, if not most applications, utilizing UV opaque reservoirs and plungers, with UV transparent fastener bodies may be the most cost effective approach to use.

It is possible to form the reservoir 34 and plunger 38 of a clear plastic (one transparent to visible light) but opaque to ultraviolet light. For example, an additive identified as Ashland UV81 sold by Ashland Chemical Company may be added to clear polyethylene or polypropylene to render the same sufficiently opaque to UV radiation as to be satisfactory for use in molding the reservoir and plunger. An advantage of a reservoir and plunger which may be transparent to visible light but opaque to UV radiation is to enable visual inspection of reservoir/plunger combinations to verify that there is photocuring adhesive in the reservoir.

Instead of forming both the reservoir and plunger of material opaque to UV radiation but transparent to visible light, only one of the two may be transparent to visible light. For example, the plunger may be transparent to visible light and determining whether the reservoir is properly filled may be visually determined by inspection through the plunger. Or the reverse arrangement may be utilized and inspection conducted through the wall of the reservoir.

There may be instances where it is desirable to use a material for the reservoir which is not opaque to UV radiation. In such instance the body 32 of the fastener must be opaque to the UV radiation but the flange nevertheless transparent thereto. In such cases the outer or inner surfaces of the body 32 may be coated with a paint that is opaque or the locator may be made by a two-shot molding technique where the body 32 is molded of a UV opaque resin and the flange 40 of a UV transparent resin.

In those instances where the fastener is to be applied to UV transparent substrates, of course the fastener body, flange 40 and plunger 38 may be opaque, and the UV radiation may be directed against the opposite side of the substrate.

In FIGS. 4, 5A and 5B somewhat different fasteners are shown though they work on exactly the same basis as that previously described. These fasteners are of a so-called Christmas tree design wherein the fastener is pushed through a hole 30a or 30b that is slightly smaller in diameter than the barbs on post 32a or 32b. These fasteners allow for adjustment in the distance they may be pressed through the holes 30 and 30b and still hold the fastener in the hole. Because it may be difficult to find the holes 30a or 30b when positioning the window in the window opening, these fasteners have a long guide stem 50a or 50b which may more easily enter the holes to guide the fastener thereinto. After the fastener is in place, the stem may be broken off as shown in FIG. 5b. Interiorly, these fasteners will have reservoirs and plungers, and the bodies and flanges will be made of the types of materials and of an opaqueness as previously described. Obviously, other materials may be utilized for the fasteners, and for that matter also for the photocuring adhesive than that specified herein as long as the materials will yield the results as above described.

While I have shown the quick-setting, photocuring adhesive being stored in a separate reservoir with a piston, both made of UV opaque plastic, and the flange 40 being UV transparent, it is to be understood that the adhesive may be stored directly in a cavity, serving as a reservoir, in the fastener body without the use of a separate reservoir, provided measures are taken to prevent UV light from reaching the adhesive. To this end, the body surrounding the adhesive may be painted with a UV opaque coating or the material of the body may be opaque while the flange 40 is UV transparent. As mentioned, this may require manufacture of the body members using a two-shot molding technique. Other variations or combinations of UV opaque and transparent materials may suggest themselves to those skilled in this art in view of the foregoing description.

While I have shown the fastener simply as a device with a tapered locating nose, the fastener may be shaped to provide a wide variety of fastening or locating designs.

For curing the quick-setting photocuring adhesive, sunlight, or artificial light may be used provided the appropriate band of the spectrum is included.

With the use of photocuring adhesives, it may be desirable to provide a thicker layer of adhesive at the interface between the flange 40 and the substrate (glass, etc.). To accomplish this, the surface of the flange 40 opposed to the substrate may be provided with raised portions such as small dimples 58 scattered over its surface of predetermined height which will space the flange 40 from the glass a determined distance to provide an adhesive thickness as desired. Instead of dimples, channels may be used as suggested in B1 5,044,852 and 5,277,520. Alternatively, radiating ribs could be used.

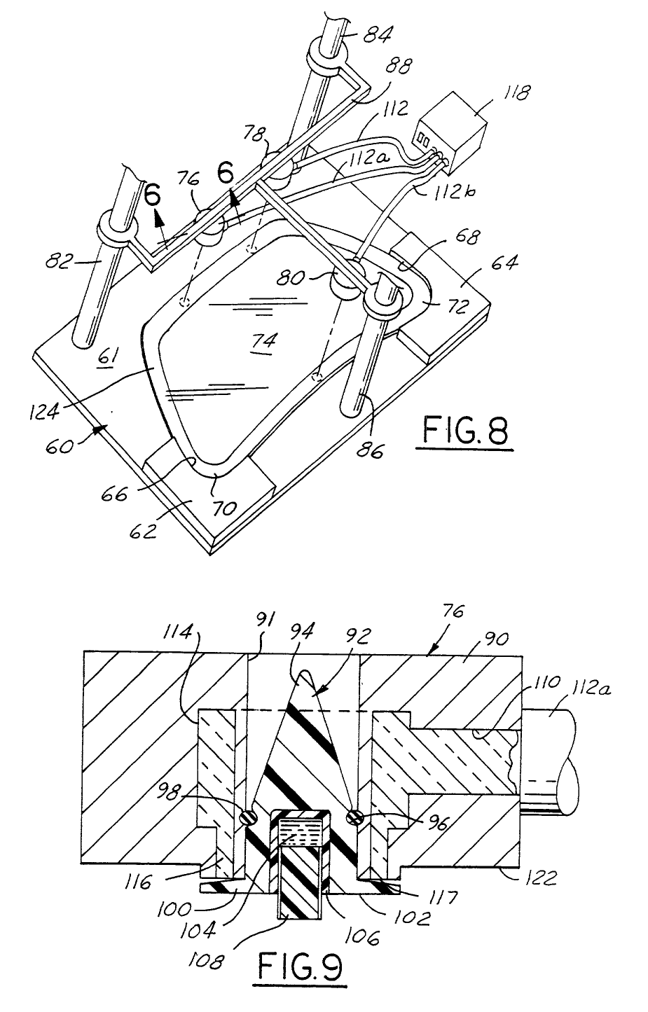

In FIG. 8, we have schematically shown apparatus for affixing self-dispensing UV-curable adhesive fasteners to a substrate, more specifically to a window to be installed in an automotive vehicle body. The fasteners, as previously described, are received in locators in the vehicle body and position and hold the window while construction adhesive between the window and vehicle body cures. This prevents the window from shifting and breaking loose from the construction adhesive during assembly of the vehicle body on an assembly line in an automotive assembly plant. The apparatus as shown in FIG. 8 includes a jig 60 comprising a table 61 on which are locating blocks 62 and 64 provided with contoured cutouts 66 and 68 adapted to receive the corners 70 and 72 of a window 74 which is to be mounted in an automotive vehicle body. The blocks 62 and 64 will accurately locate the window on the table 61.

Applicators 76, 78 and 80 are positioned above the table 61 for vertical movement on guideposts 82, 84 and 86, being carried by a supporting structure 88 slidably mounted on the posts 82, 84 and 86. Means, not shown, are provided for moving the support 88 vertically to carry the applicators toward and away from the window 74. A greater or lesser number of applicators may be provided as required by the circumstances.

Each applicator, as shown in FIG. 9, comprises a housing 90 having therein an outwardly opening fastener receiving chamber 91 within which a fastener is disposed for affixation to a window or a substrate in the jig 60. The fastener may have a cone-shaped end portion 94 to be received within locating holes or the like in the automobile body as previously described. A fastener holder is provided on the applicator for positioning a fastener in the chamber with a flange 100 disposed to abut the surface to which the fastener is to be affixed. For this purpose, the fastener may have a circumferential indentation 96 into which is snapped a spring retainer such as an O-ring retainer 98 mounted in the applicator for temporarily retaining the fastener in the applicator preparatory to adhering the fastener to the substrate or window 74. The fastener is provided with a UV transparent flange 100 which has a flat surface 102 for juxtaposing the substrate or window 74 when the applicator carries the fastener against the window.

In the embodiment shown in FIG. 9, the body of the fastener 92 is formed of a UV transparent material. To prevent the UV-curable adhesive 104 from curing prematurely, the adhesive is disposed within a cartridge 106, opaque to UV-curing radiation. The cartridge is closed by an opaque piston 108 similar to the arrangement previously described.

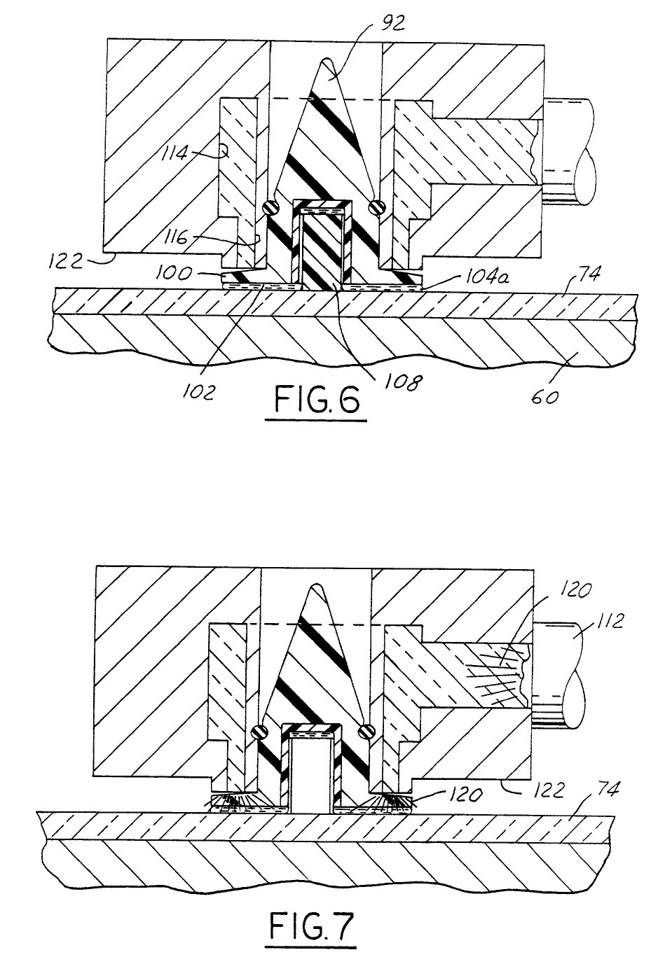

The housing 90 of each applicator is formed of a material opaque to the UV radiation which will cure the adhesive. Each applicator housing 90 is provided with a radial passageway 110 extending from a conductor such as the conductor 112a to an annular chamber 114 terminating in a focusing chamber 116. The conductor 112a may comprise a bundle of UV radiation-conducting fibers which extend through the passageway 110 and into the chambers 114 and 116 terminating in an annular radiation emitting end 117 at the lower end of chamber 116, i.e., at the face of the body 90 as best shown in FIG. 9. The annular emitting end of the conductive fibers, which terminate at the lower face 117 of the applicator, creates an annular beam of radiation directed against the transparent flange 100 as shown in FIG. 7.

Similar to the operation previously disclosed and described, when the applicator carries the fastener 92 against the substrate or window 74, as in FIG. 6, it causes the piston 108 to be displaced into the cartridge and the adhesive therein flows downwardly and radially outwardly between the bottom face 102 of the flange and the opposing surface of the substrate or window 74. The UV radiation which has entered the annular cavities 114 and 116 and directed at and through the transparent flange 100 causes a rapid curing of the adhesive in the interface between the flange and the substrate or window.

The conductors 112, 112a and 112b are connected to a source 118 of UV radiation schematically shown in FIG. 8. The conductors may comprise bundles of conductive fibers. The construction and arrangement of the conductive fibers is such that an annular UV radiation beam is directed against the flange 100 of the fastener. The source 118 of the radiation is programmed to cause the radiation to pass through the conductors 112 to the associated applicator when the applicator has pressed the piston 108 into the cartridge as shown best in FIG. 7. In such figure, the radiation is depicted at 120. It will be noted that the face 122 of the applicator surrounds the fastener and provides an annular shield against escape of the radiation so that the radiation does not impinge on the eyes of personnel working at the apparatus. In a working model of the apparatus, the diameter of the applicator was on the order of three inches which provides somewhat more than one inch of overhang of the surface 122 circumjacent the fastener and the distance between the surface 122 and the window 74 approximately .10 .14 millimeter and preferably .12 millimeter. This is a small enough gap to effectively shield the area beyond the applicator from UV radiation.

After the fastener has been adhered to the substrate or window 74, the applicator is raised vertically and the O-ring-like retainer 98 snaps out of the circumaxial groove 96 in the fastener releasing the fastener from the applicator. Other forms of temporary retention for the fastener will occur to those skilled in the art.

If desired, the apparatus schematically shown in FIG. 8, may be arranged adjacent are assembly line in an automobile assembly plant and the fasteners may be affixed to the windows just prior to the windows being installed in an automotive vehicle body passing down the assembly line. This is advantageous in that it avoids the problems associated with applying the fasteners at a remote location, then packaging the windows with the fasteners attached, in a suitable package so the fasteners are not knocked loose, and then shipping them to the automotive assembly plant. This is, of course, made possible by the quick curing of the UV-cured adhesive as taught herein.

It is also advantageous in certain circumstances to prime the frit coating 124 on the marginal edge of the window, as shown in FIG. 8 to improve adhesion of the fasteners. One percent (1%) Vinyltrimethoxysilane in isopropanol has been found to be useful for this purpose. The following are sources for such adhesion enhancers:

Essex primer 435-18 termed BETASEAL® Glass Primer, manufactured by Essex Specialty Products, Inc., 1250 Harmon Road, Auburn Hills, Mich. 48326, now The Dow Chemical Company, Midland, Mich.

Ashland Primer #7780 termed GLASSGRIP, manufactured by Ashland Chemical Co., P.O. Box 2219, Columbus, Ohio.

Witco Primer, Silquest A-1100 silane manufactured by C. K. Witco Corp. of 199 Benson Road, Middlebury, Conn. 06749, having a chemical name: Gamma-Aminopropyltriethoxysilane.

OSI Specialties primer Silquest A-1120 silane manufactured by Compton Corp., 1 American Lane, Greenwich, Conn. 06831, having the chemical name: N-beta-(aminoethyl)-gamma-aminopropyltrimethoxysilane.

Such primers are applied to the frit coating and allowed to dry before the fasteners are attached to the primed area.

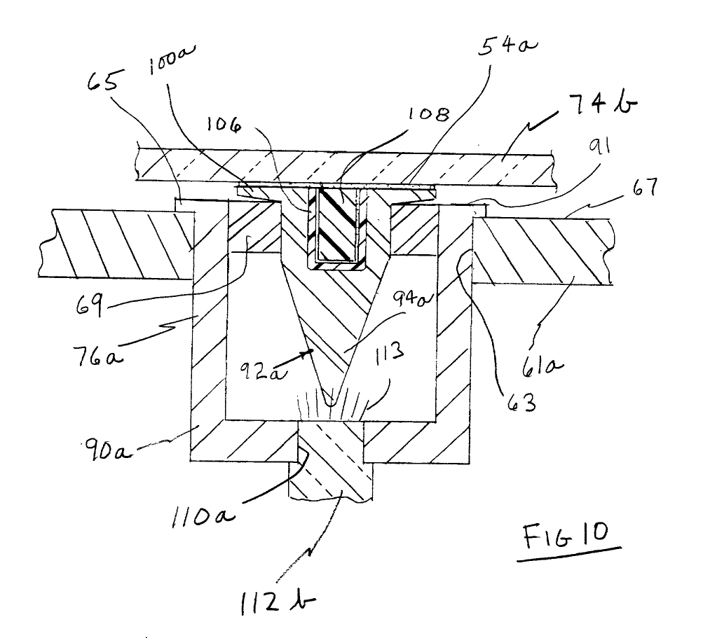

In FIG. 10, I have shown a modified form of the apparatus for attaching the fasteners to a substrate 74b, such as an automotive vehicle window. The arrangement is similar to that shown in FIGS. 6-9 except for the important differences mentioned hereafter. Rather than using applicators 76, 78 and 80 positioned above the table 61 as shown in FIG. 8, the applicators in this modified arrangement are mounted in the table 61a so that they are disposed beneath the substrate 74b, such as a vehicle window, and the fastener receiving chambers open upwardly. In the structure shown in FIG. 10, the applicator 76a comprises a cylindrical opaque housing 90a received in a circular opening 63 in the table 61a. The housing 90a is provided with a flange 65 overlying the upper surface 67 of the table 61a thereby preventing the applicator from dropping through the table.

The applicator housing 90a is hollow and at its upper end includes an annular UV-transparent wall 69 serving as a fastener locator for supporting the fastener 92 on the applicator substantially as shown in FIG. 10. The length of the housing 90a is to be sized to receive the particular fastener to be utilized, as for example rather short fasteners shown in FIG. 3, or longer ones as shown in FIGS. 4 and 5a. The wall 69 may be secured within the housing 90a in any suitable fashion. At the lower end of the housing 90a, there is an aperture 110a within which is received a UV conductor 112b for delivering ultraviolet radiation to a fastener as exemplified at 92 in FIG. 10. The radiation is schematically indicated at 113. The radiation is delivered axially of the fastener at the cone-shaped end 94a, i.e., at that end of the fastener opposite the end to be attached to the substrate 74b. In this construction, the O-ring retainer 98 used in FIG. 9 may be eliminated in view of the mounting of the applicator beneath the substrate 74b as gravity will hold the fastener within the applicator 76a.

The fastener of FIG. 10 has a body of transparent plastic such as a bisphenol A polycarbonate sold under the trademark Makrolon™ 2405 550115 by Bayer Corporation. In addition, good results may be obtained by forming the fasteners of Durethane™ T 40 ZS 5014/3 also sold by Bayer Corporation.

I have discovered that by directing the ultraviolet radiation axially of the fastener as shown in FIG. 10 as opposed to bringing it in radially as shown in FIGS. 7-9, inclusive, the adhesive 54a will cure much more rapidly, such as one-half the time that was required when the UV radiation was brought in radially as in FIGS. 7-9. By virtue of the use of a UV-transparent annular wall 69, or locating means, the radiation 113 may pass therethrough and into the flange as well of course as passing down through the UV-transparent body 92a of the fastener and thence into the transparent flange 100a.

Details of the cartridge 106 and the plunger 108 need not be further described as they correspond to the structure previously discussed in connection with FIGS. 7-9. If desired, the applicator 76a of FIG. 10 may be mounted so that its upper surface 91 is flush with the surface 76 of the table 61a and other means may be provided for retaining the housing within the table. Because it is contemplated that the fasteners 92a will be mounted to the frit-coated margin of the window 74b, ultraviolet radiation will be trapped by the frit for the most part below the window.

With the arrangement shown in FIG. 10, the applicators are disposed in the table 61a as mentioned, and arranged in the pattern desired, such as that shown in FIG. 8. The fasteners are then placed in the applicators and the window glass is moved over above the table and positioned thereon by any suitable positioning devices such as the blocks 62 and 74 previously described. The window glass is pressed down against the flanges 100a of the fasteners supported by the applicators to cause the plungers of the fasteners to be depressed into their cartridges expelling the UV-curable adhesive into the interface between the window glass and the flanges 100a of the fasteners. Once the adhesive has been expelled into the interface, UV radiation may be delivered to each of the applicators by the conduit 112b to deliver radiation 113 against the nose of each of the fasteners.

While I have shown the applicator 76a being disposed within the table 61a and the pressing down of the window against the fasteners to cause depression of the plunger 108 into the reservoir 106, it will be understood that the applicators 76a may be supported in any convenient fashion and raised vertically toward and away from the window glass should that be a desirable alternative. Also, the glass may be supported if desired above the fastener flanges by suitable retractable means to allow the window glass to be lowered in a controlled fashion against the fasteners.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An apparatus for affixing fasteners to a substrate utilizing a UV-curable adhesive, comprising:
an applicator for receiving a fastener and supporting the fastener to press a UV transparent portion thereof having UV-curable adhesive thereon into contact with a substrate on which the fastener is to be installed; and
a source of UV radiation on the applicator arranged to shine UV radiation against the transparent portion of a fastener supported by the applicator as such transparent portion is pressed against a substrate when the fastener is applied thereto by the applicator.

2. The apparatus of claim 1 characterized in that said applicator includes a fastener retainer for engaging and releasably holding a fastener for application to a substrate.

3. The apparatus of claim 1 wherein said applicator has a UV light source arranged to direct UV light axially through a fastener in the applicator.

4. The apparatus of claim 1 wherein the transparent portion of the fastener is an annular flange and the UV light source is arranged to shine an annular beam of UV light against the flange of the fastener pressed against a substrate by the applicator.

5. The apparatus of claim 1 wherein said applicator defines a UV light confining barrier for essentially preventing escape of UV light from the applicator except that directed against the transparent portion of the fastener.

6. The apparatus of claim 1 characterized in that said applicator has a fastener receiving cavity for receiving at one end a fastener to be attached to a substrate and said source of UV radiation is disposed at the opposite end of such cavity and arranged to shine UV radiation axially of a fastener received in the cavity.

7. The apparatus of claim 1 wherein the applicator has an outwardly opening chamber for receiving a fastener to be affixed to a substrate, and a UV light source disposed in the chamber and arranged to focus UV light axially of the chamber against a fastener received in the chamber.

8. The invention defined by claims 1-7 wherein the substrate is a window to be installed in automotive vehicle bodies.

9. An apparatus for quickly affixing self-dispensing UV curable adhesive fasteners on windows to be installed in automotive vehicle bodies, comprising:
a jig for receiving the window to be installed;
a plurality of fastener applicators supported on the jig for affixing fasteners to the window at predetermined locations;
each applicator having a fastener receiving UV light confining chamber within which the fastener is disposed during affixation to a window in the jig;
a fastener holder in the chamber for cooperating with a fastener in the chamber to releasably hold a fastener therein with a flange on the fastener positioned to abut a window in the jig when the applicator or the window is moved to press the flange of a fastener in the chamber against the window; and
a UV light source within said chamber to focus UV light on the fastener disposed in the chamber.

10. An apparatus for quickly affixing fasteners containing UV curable adhesive to a surface comprising, in combination:
an applicator having an outwardly opening fastener receiving chamber;
a fastener holder on the applicator for positioning a fastener in the chamber with a flange on the fastener disposed to abut the surface to which the fastener is to be affixed; and
a source of UV light communicating with the chamber and arranged to direct UV light against a fastener in the chamber and essentially confine the light to the chamber.

11. A self-dispensing fastener utilizing photocuring, quick-setting adhesive comprising, in combination:
a body having an adhesive reservoir therein and an integral flange;
a plunger in said reservoir sealing the same and projecting therefrom for depression into the reservoir to expel adhesive in the reservoir into the interface formed between said flange and a surface when the fastener is pressed thereagainst;
a photocuring adhesive in the reservoir; and
said reservoir and plunger being formed of an opaque material and said flange formed of a transparent material.

12. The fastener of claim 11 wherein all of said fastener is transparent to UV radiation except said plunger and reservoir.

13. The invention defined by claim 11 wherein said reservoir is separate from the body.

14. The invention defined by claim 13 wherein said body is UV transparent.

15. The invention of claim 11 wherein said reservoir is formed in the body of a UV opaque material and the flange of the body is formed of a UV transparent material.

16. The invention of claim 10 wherein said body is formed of a UV transparent material and there is a UV opaque coating on the body covering the reservoir.

17. The invention as defined in claim 11 wherein said flange is provided with raised portions opposed to a surface to which the fastener is to be secured to determine the thickness of the adhesive layer expelled in the said interface.

18. The invention defined by claim 11 wherein said plunger projects from the reservoir below said flange for engagement with a surface to which the fastener is to be secured to expel adhesive from the reservoir when the fastener is pressed against such surface.

19. The method of locating a window in a motor vehicle comprising the steps of:
providing locating holes in the vehicle body at the window opening;
pressing self-dispensing adhesive locators, utilizing quick-acting photocuring adhesive and a UV transparent flange, against the window to extrude the adhesive into the interface between the flange and the window;
directing UV radiation against the fastener to cure the adhesive in the interface between the window and the flange; and
mounting the window in the motor vehicle by aligning the locators on the window with the locator holes in the vehicle body and pressing the window into the window opening.

20. A vehicle window for installation in the window opening of a vehicle during assembly on the line comprising:
a transparent vehicle window having a UV opaque frit around the marginal edge;
a plurality of locators attached to the window in overlying relation to the frit at the marginal edge and spaced apart to be received in predetermined holes in the vehicle body; and
said locators having a quick-setting UV cured adhesive securing the locators to the window over said frit.

21. A reservoir plunger unit for use in a self-dispensing fastener utilizing photocuring adhesive comprising, in combination;
a reservoir for containing a quantity of photocuring adhesive to be dispensed;
a plunger inserted in the reservoir for expelling the adhesive;
said reservoir and plunger being opaque to UV radiation; and
at least one of the reservoir or plunger being transparent to visible light.

22. The invention of claim 21 wherein the reservoir is transparent to visible light.

23. The invention of claim 21 wherein the plunger is transparent to visible light.

24. The invention of claim 21 wherein both the reservoir and plunger are transparent to visible light.

25. The invention defined by claim 19 wherein each of said locators has a portion overlying the vehicle window with a layer of UV-cured adhesive between such portion and the window and wherein such portion is transparent to UV light.

26. The method of locating a window in a motor vehicle comprising the steps of:
providing locating holes in the vehicle body at the window opening;
providing a plurality of fasteners each having a first portion for overlying the window and being transparent to UV light, and a second portion for reception in said holes;
coating said first portion with a quick-setting UV-cured adhesive;
pressing the coated first portion of each fastener against the window to dispose the adhesive-coated portion against the window and, while holding the same in such a position, exposing the first portion to UV light to cure the adhesive; and
positioning the window in a motor vehicle and inserting the second portion of each fastener in the provided locating holes.

27. The method of claim 26 wherein both the first and second portions of the fasteners are transparent into UV light and while pressing the first coated portion against the window exposing both portions to UV light.

28. A method of locating and temporarily securing a window in a motor vehicle body to prevent movement between the window and vehicle body during curing of a construction adhesive which permanently secures the window in the body, comprising the steps of:
providing self-dispensing adhesive fasteners containing a quick-setting photocuring adhesive in an adhesive reservoir closed by a piston, both reservoir and piston being opaque to photocuring radiation to prevent premature curing of the adhesive in the reservoir;
providing locating devices on the vehicle body at the window opening;
pressing said self-dispensing adhesive fasteners against the window to expel the quick-setting adhesive from each reservoir into the interface between a flange on each fastener and the window, and wherein said flange and/or said window at the interface is transparent to photocuring radiation;
directing photocuring radiation through said flange and/or window against said interface at each fastener to cure the adhesive in said interface; and
mounting the window in the motor vehicle by aligning the fasteners on window with the locating devices on the vehicle body and pressing the window into the window opening and against a construction adhesive between the window and the body.

29. The method of claim 28 wherein said flange on the fasteners is transparent to photocuring radiation and the photocuring radiation is directed against such flange to cure the adhesive.

30. The method of claim 28 wherein the window to be located has areas transparent to photocuring radiation and pressing the fasteners against the window at said transparent areas to squeeze the adhesive across the interface between said flange and said areas of the window to cure the adhesive.

31. A method of locating a window in a window opening of a motor vehicle comprising the steps of:
providing locating devices on the vehicle body at the window opening;
providing a plurality of window fasteners each having a first portion for overlying the window and being transparent to photocuring radiation, and a second portion for cooperation with said locating devices;
coating said first portion with a quick-setting photocuring adhesive;
pressing the coated first portion of each fastener against the window to dispose the adhesive-coated portion against the window and, while holding the same in such a position, exposing the first portion to photocuring radiation to cure the adhesive;
positioning the window in a motor vehicle and aligning the second portion of each fastener with the provided locating devices; and
pressing the window into the window opening while engaging the second portion of the fasteners with the locating devices.

32. The method of claim 31 wherein prior to pressing the fasteners against the window to expel the quick-setting adhesive, coating the exposed surface of the window with an adhesion-enhancing material selected from the group consisting of Essex Primer 435-18, Ashland Primer 7780, Witco Primer Silquest A1100 silane and OSI Specialties primer Silquest A-1120 silane.

33. The method of securing a part to a substrate comprising:
providing a part formed of a UV transparent material and having a surface to be juxtaposed against a substrate with the remainder of the part upstanding therefrom;
coating said surface with a UV-curing adhesive; and
while holding said surface against the substrate directing UV radiation against the portion of the part upstanding from the substrate to cure the adhesive.
